(19) United States
(12) Patent Application Publication
(10) Pub. No.: US 2023/0343104 A1
(43) Pub. Date: Oct. 26, 2023

(54) SYSTEMS AND METHODS FOR PROVIDING A VEHICLE-BASED SECURITY SYSTEM

(71) Applicant: Ford Global Technologies, LLC, Dearborn, MI (US)

(72) Inventors: Dmitry Ogorodnikov, Amherstburg (CA); Steven Anthony Chapekis, Escanaba, MI (US)

(73) Assignee: Ford Global Technologies, LLC, Dearborn, MI (US)

(21) Appl. No.: 17/659,852

(22) Filed: Apr. 20, 2022

(51) Int. Cl. G06V 20/58; B60W 40/02

(52) U.S. Cl. CPC G06V 20/58; B60W 40/02; B60W 2420/52; B60W 2420/42; B60W 2554/4029

(57) ABSTRACT

The disclosure generally pertains to systems and methods for providing a vehicle-based security system. In an example method, at least a first image and a second image may be received from an infrared camera associated with a vehicle. A thermal 3-dimensional map may then be constructed from the first image and the second image. An area of interest may be identified in the thermal 3-dimensional map. A visual camera associated with the vehicle may then be instructed to obtain a third image including the area of interest. The third image including the area of interest may then be received, and a living object in the third image may be determined. A notification associated with the living object may then be transmitted.

### BACKGROUND

Vehicle-based security systems may not presently be configured with a combination of infrared cameras and visual cameras for performing image processing and feature identification based at least in part on thermal images and/or video feeds obtained from the infrared cameras. For example, living objects, inanimate objects, such as landmarks, and/or people may be identified to a vehicle owner based on a combination of the images and/or video feeds obtained from the infrared cameras and the visual cameras.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example vehicle-based security system in accordance with an embodiment of the disclosure.

FIG. 2 illustrates an example implementation of a vehicle-based security system in accordance with an embodiment of the disclosure.

FIG. 3 illustrates an example implementation of a vehicle-based security system in accordance with an embodiment of the disclosure.

FIG. 4 depicts a flow chart of an example method for implementing a vehicle-based security system in accordance with the disclosure.

FIG. 5 depicts a block diagram of an example machine upon which any of one or more techniques (e.g., methods) may be performed, in accordance with an embodiment of the disclosure.

### DETAILED DESCRIPTION

### Overview

In terms of a general overview, certain embodiments described in this disclosure are directed to systems and methods for providing a vehicle-based security system. In an example method, at least a first image and a second image may be received from an infrared camera associated with a vehicle. A thermal 3-dimensional map may then be constructed from the first image and the second image. An area of interest may be identified in the thermal 3-dimensional map. A visual camera associated with the vehicle may then be instructed to obtain a third image including the area of interest. The third image including the area of interest may then be received, and a living object in the third image may be determined. A notification associated with the living object may then be transmitted.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component.

Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “security” may be used interchangeably with the word “surveillance” and the word “patrol.” The word “device” may be any of various devices, such as, for example, a user device such as a smartphone or a tablet, a smart vehicle, and a computer.” The word “sensor” may be any of various sensors that can be found in a vehicle, such as cameras, radar sensors, Lidar sensors, and sound sensors.

It must also be understood that words such as “implementation,” “scenario,” “case,” and “situation” as used herein are an abbreviated version of the phrase “in an example (“implementation,” “scenario,” “case,” “approach,” and “situation”) in accordance with the disclosure.” Furthermore, the word “example” as used herein is intended to be non-exclusionary and non-limiting in nature.

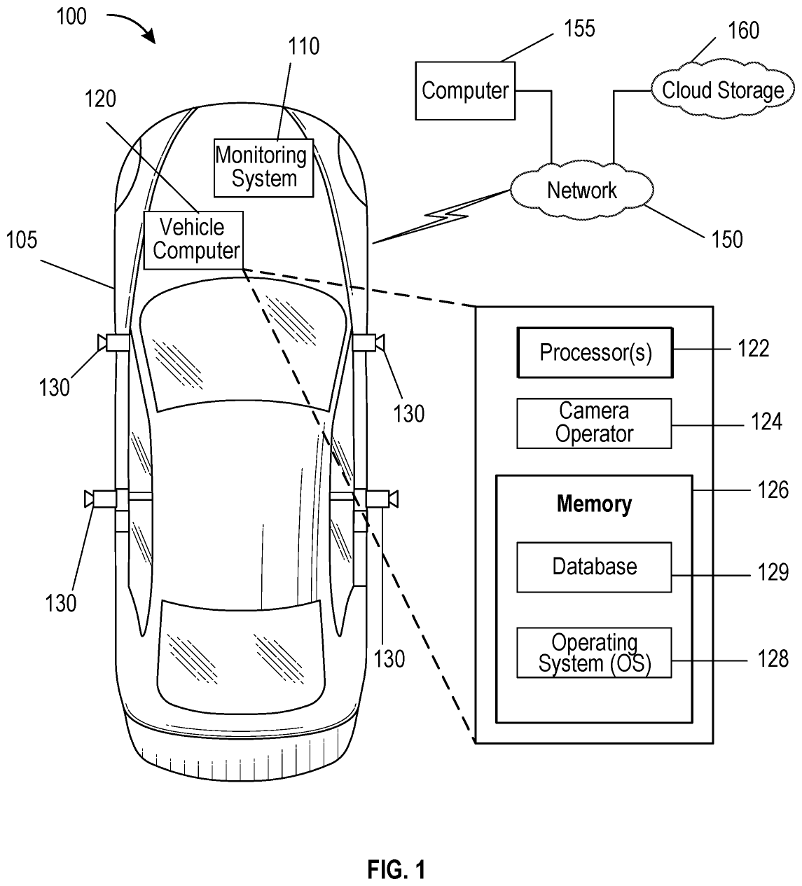

FIG. 1 illustrates an example vehicle-based security system 100 in accordance with an embodiment of the disclosure. The vehicle-based security system 100 may be implemented in a vehicle 105, which may be any of various types of vehicles such as, for example, a gasoline powered vehicle, an electric vehicle, a hybrid electric vehicle, an autonomous vehicle, a sedan, a van, a minivan, a sports utility vehicle, a truck, a station wagon, or a bus.

The vehicle 105 may further include components such as, for example, a monitoring system 110, a vehicle computer 120, and at least one camera 130. The vehicle 105 may further include various types of sensors and detectors configured to provide various functionalities. The vehicle computer 120 may perform various operations associated with the vehicle 105, such as controlling engine operations like turning the vehicle 105 on and off, fuel injection, speed control, emissions control, braking, and other engine operations. The at least one camera 130 may be mounted on any portion of the vehicle 105 and may be used for various purposes, such as, for example, to record video activity in an area surrounding the vehicle 105. In some embodiments, the at least one camera 130 may include various cameras that are already implemented on the vehicle 105, such as, for example, Advanced Driver Assistance Systems (ADAS), exterior rear-view mirrors, traffic cameras, B-Pillar cameras, and other cameras, The vehicle computer 120 may also perform various operations associated with the vehicle-based security system 100.

In some embodiments, the at least one camera 130 may be a convertible camera. A convertible camera may have two modes, where the convertible camera functions as an infrared camera in a first mode and the convertible camera functions as a visual camera in a second mode. In other embodiments, more than one camera 130 may be mounted on the vehicle 105, and at least one camera of the more than one camera 130 is a visual camera while at least one camera of the more than one cameras 130 is an infrared camera.

In some embodiments, the monitoring system 110 and the vehicle computer 120 are configured to communicate via a network 150 with devices located outside the vehicle 105, such as, for example, a computer 155 (a server computer, a cloud computer, etc.) and/or a cloud storage 160.

The network 150 may include any one, or a combination of networks, such as, for example, a local area network (LAN), a wide area network (WAN), a telephone network, a cellular network, a cable network, a wireless network, and/or private/public networks such as the Internet. The network 150 may support any of various communications technologies, such as, for example, TCP/IP, Bluetooth®, near-field communication (NFC), Wi-Fi, Wi-Fi Direct, Ultra-Wideband (UWB), cellular, machine-to-machine communication, and/or man-to-machine communication.

In some embodiments, the vehicle computer 120 may include a processor 122, a camera operator 124, and a memory 126. It must be understood that the camera operator 124 is a functional block that can be implemented in hardware, software, or a combination thereof. Some example hardware components may include a signal processor. Some example software components may include a video analysis module, a power module, and a signal processing module. The processor 122 may carry out advertisement selection operations by executing computer-readable instructions stored in the memory 126. The memory 126, which is one example of a non-transitory computer-readable medium, may be used to store a database 129 for storing data and an operating system (OS) 128.

In some embodiments, the monitoring system 110 may be configured to include various components having functions associated with executing the vehicle-based security system 100. Further, the vehicle computer 120 may be further configured to assist in performing image processing and communicating with a cloud processing unit. In an example embodiment, the monitoring system 110 may be communicatively coupled to the vehicle computer 120 via wired and/or wireless connections. More particularly, the monitoring system 110 may be communicatively coupled to the vehicle computer 120 via a vehicle bus that uses a controller area network (CAN) bus protocol, a Media Oriented Systems Transport (MOST) bus protocol, and/or a CAN flexible data (CAN-FD) bus protocol. In another embodiment, the communications may be provided via wireless technologies such as Bluetooth®, Ultra-Wideband (UWB), cellular, Wi-Fi, ZigBee®, or near-field communications (NFC).

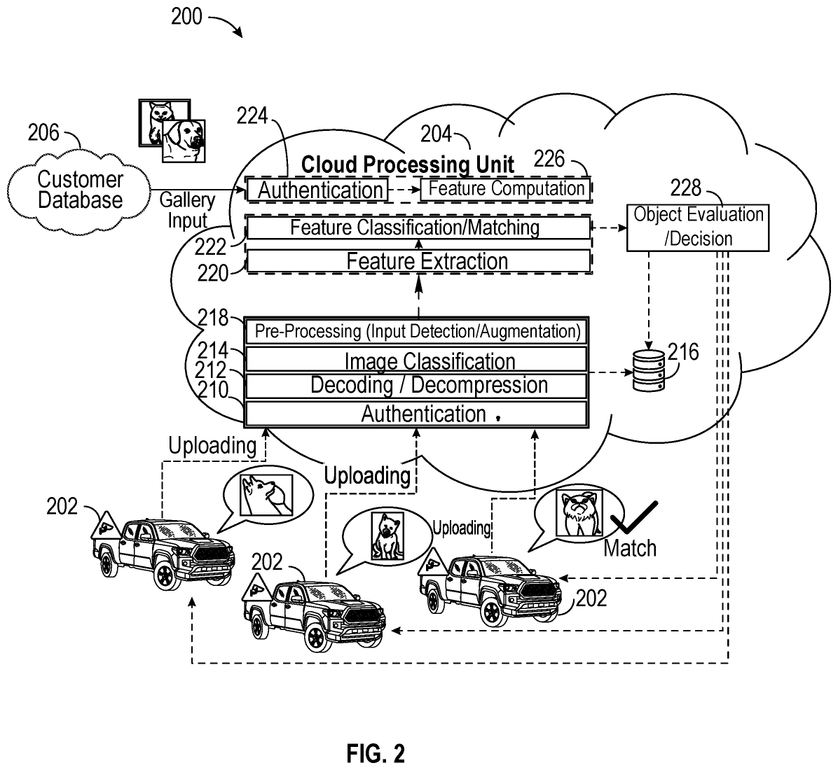

FIG. 2 illustrates an example implementation of a vehicle-based security system 200 in accordance with an embodiment of the disclosure. The vehicle-based security system 200 may be configured to use cameras mounted on vehicles to obtain image and/or video inputs. In one example, the vehicle-based security system 200 may be configured to use both infrared cameras and visual cameras. The infrared cameras on each vehicle may be used to capture images and/or videos of surrounding areas proximate to the each vehicle and thermal measurements associated with the people and/or objects depicted in each image and/or video. The visual cameras on each vehicle may be used to capture images and/or videos of surrounding areas proximate to each vehicle.

In some embodiments, at least one vehicle 202 may be configured for participation in the vehicle-based security system 200. At least one camera on each vehicle 202, which may function as an infrared camera, a visual camera, or both, may be configured to obtain images and/or video feed of a field of view of the vehicle 202. In some embodiments, multiple images and/or video feeds may be taken at each vehicle 202. The multiple images and/or video feeds may be stitched together in a particular format for uploading to a cloud processing unit 204. For example, the multiple images and/or video feeds may be stitched together to include a first panel including images and/or video feeds from a north direction, a south direction, an east direction, and a west direction. The multiple images and/or video feeds may be further stitched together to include a second panel including images and/or video feeds from a northeast direction, a southeast direction, a northwest direction, and a southwest direction. The multiple images and/or video feeds may be additionally stitched together to include a third panel including images and/or video feeds from a top view and a bottom view. The images and/or video feeds from each direction may include a stamp to clarify the navigational coordinates associated with the images and/or video feeds and whether each image and/or video feed was obtained by the infrared camera or the visual camera. In some instances, the stamp may be masked.

In some embodiments, when an image and/or video feed is uploaded from the vehicle 202 to the cloud processing unit 204, the image and/or video feed is authenticated at an authentication module 210 as being transmitted from the vehicle 202. After authentication, the image and/or video feed may undergo a decoding and/or decompression process at a decoding/decompression module 212. Subsequently sorting, mapping, virtualization, and/or storage may be performed at an image classification module 214. The image and/or video feed may be stored at a local memory 216 within the cloud processing unit 204.

The image and/or video feed may then undergo pre-processing at a pre-processing module 218, which may include input detection and augmentation. Features may then be extracted from the image and/or video feed at a feature extraction module 220, and the features may subsequently be classified and matched at a feature classification and matching module 222 based on images from a database of images. For example, the database of images may be a third party database 206 having a collection of images and/or video feeds. The images received from the third party database 206 may be authenticated at a database authentication module 224, and the features within the images from the third party database 206 may be computed at feature computation module 226. At an object evaluation or decision module 228, the features within the images from the third party database 206 may then be matched against the images and/or video feeds received from the visual cameras, a matching evaluation and decision may be made to determine the level of similarity between the images from the third party database 206 and the images and/or video feeds received from the visual cameras. Once a matching evaluation and decision has been made, the decision may be stored in the memory 216 of the cloud processing unit 204, and matching decisions may be transmitted. In some instances, the matching decisions may be transmitted from the object evaluation or decision module 228 to the vehicle 202.

In some embodiments, the notifications may be transmitted to the vehicle owner via the vehicle and/or a mobile device associated with the vehicle owner. In some embodiments, a notification may only be transmitted if the image comparison detects a match between the image and/or video feed and an image in the database. A match may be detected if the similarities between the image and/or video feed and the image in the database exceeds a minimum predetermined match percentage threshold.

In some embodiments, as depicted in FIG. 2, multiple images and/or video feeds received from various vehicles 202 may be transmitted to a cloud processing unit 204, which may then decode, decompress, sort, store, analyze, and perform other operations associated with the multiple images and/or video feeds. For example, the cloud processing unit 204 may receive at least two images from infrared cameras associated with each vehicle 202. In some embodiments, the cloud processing unit 204 may be configured to construct a thermal 3-dimensional map based on images, for example, the at least two images received from the infrared cameras associated with each vehicle 202, and/or video feeds received from infrared cameras, compass data, and/or navigational data associated with the vehicle (for example, global positioning system (GPS) data). In some instances, the construction of the thermal 3-dimensional map may occur at the image classification module 214. In other instances, the construction of the thermal 3-dimensional map may occur at the pre-processing module 218.

The cloud processing unit 204 may then analyze the thermal 3-dimensional map and the multiple images and/or video feeds received from infrared cameras in order to detect an area of interest, and also to detect living objects, inanimate objects, such as landmarks, and/or people. In some embodiments, the cloud processing unit 204 may be configured to instruct the vehicles 202 to obtain additional images and/or video feeds from the infrared cameras at the vehicle 202 in order to construct the thermal 3-dimensional map with increased accuracy. The cloud processing unit 204 may then receive the additional images and/or video feeds from the infrared cameras at each vehicle 202. The thermal 3-dimensional map may assist in performing various functions, such as detecting living objects in areas that are either visible or invisible to visual cameras, for example, behind doors, walls, fences, and other obstacles, and detecting fresh traces of active events based on surface temperatures, for example, the detection of recently touched objects, recently used vehicles, recent vehicle paths, recent temperature increases such as fires, and other causes of raised temperatures. If the images and/or video feeds received from the infrared cameras associated with each vehicle 202 includes living objects, a body temperature associated with each living object may be determined. The living objects may be disposed inside or outside the vehicle 202.

Further, the images and/or video feeds from the infrared cameras may be repeatedly obtained so as to increase the accuracy of the thermal 3-dimensional map, to compare thermal images and/or video feeds with previous thermal images and/or video feeds to detect any differences in temperature, to trace hidden objects as the hidden objects move, to detect areas of interest for visual cameras to focus on, where the areas of interest may include objects and/or thermally active events, and to navigate autonomous vehicles in locations where visible light may not be detectable by visual cameras, for example, extremely dark or bright conditions.

In some embodiments, the cloud processing unit 204 may then identify an area of interest in the thermal 3-dimensional map. In some embodiments, the visual cameras may be configured to obtain images and/or video feeds associated with a field of view of the vehicle subsequent to the areas of interest being detected from the thermal 3-dimensional map. This may involve the visual cameras at the vehicles 202 being instructed to obtain images and/or video feeds that include the area of interest. In some embodiments, the cloud processing unit 204 may then receive images and/or video feeds including the area of interest from the visual cameras associated with each vehicle 202.

In some embodiments, after undergoing decoding and decompression at the decoding/decompression module 212, image classification at the image classification module 214, and pre-processing at the pre-processing module 218, extraction methods involving color, texture, shape, and/or dimensions may be used to compare images and/or video feed from visual cameras with images in a database of images. For example, the cloud processing unit 204 may identify an object based on the images and/or video feed received from visual cameras, subsequently determine that the object matches an image in a database of images, for example, the database 206, and then confirm the presence of the object based on the determination that the object matches the image in the database of images. In such an instance, the identification of an object based on the images and/or video feed may be performed at the feature extraction module 220, and the identification of images in the database of images may be performed at the feature computation module 226. The process of matching the object based on the images and/or video feed to database images in the database of images may then be performed at the feature classification and matching module 222. A final confirmation that the object is present in an image and/or video feed received from a vehicle 202 based on the determination that the object matches an image in the database of images may be performed at the object evaluation and decision module 228. In some instance, the database of images may be incorporated into the cloud processing unit 204, or the database of images may be a separate database communicatively coupled to the cloud processing unit 204. In some instances, the database of images may include 2-dimensional black-and-white images. The images and/or video feeds from visual cameras, for example, the images and/or video feeds from visual cameras associated with each vehicle 202, may thus be used to determine and identify living objects, inanimate objects, and/or people, track said living objects, inanimate objects, and/or people, and direct autonomous vehicles and assist in their navigation. Further, the video feeds from the visual cameras may be stored in the memory 216 of the cloud processing unit 204 or the vehicle 202 for future playback. In some instances, the cloud processing unit 204 may include a server having various hard drives and/or disk spaces, such as hard disk drives (HDDs) and solid-state drives (SSDs). In some instances, the images and/or video feed from the visual cameras may be used for headcount calculations to detect a number of people present in the image and/or video feed.

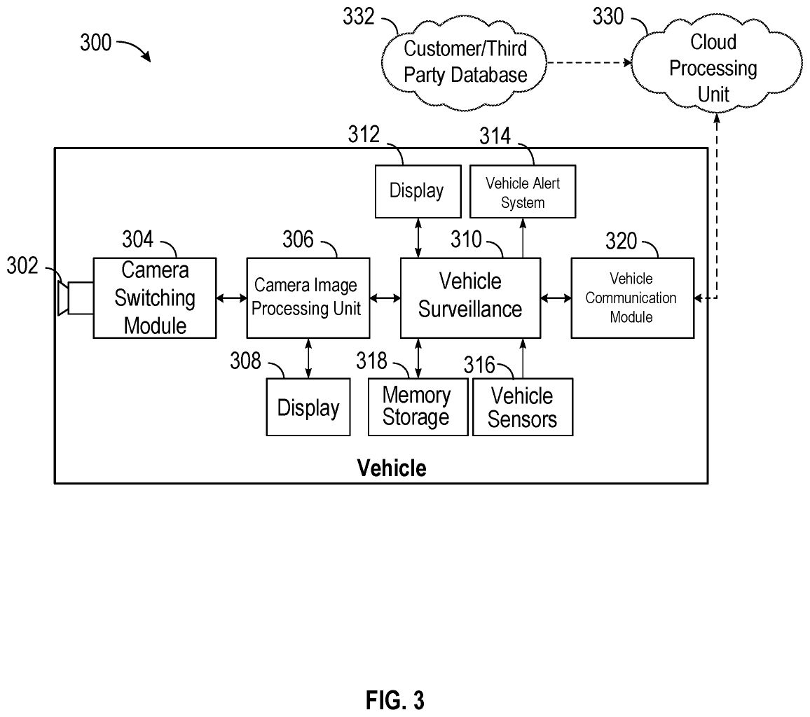

FIG. 3 illustrates an example implementation of a vehicle-based security system 300 in accordance with an embodiment of the disclosure. In some embodiments, a camera 302 having a camera switching module 304 may be mounted on a vehicle. The camera switching module 304 may configure the camera 302 to operate in two operating modes, such that the camera 302 may function as an infrared camera in one mode and may function as a visual camera in the other mode. In some embodiments, the camera 302 may be configured to be fully rotatable so as to enable a 360 degree field of view. the images and/or video feed obtained from the camera 302 may be transmitted to a camera image processing unit 306 at the vehicle. The camera image processing unit 306 may be configured to be connected to a display 308. In some embodiments, if an identification of a living object, an inanimate object, or a person is performed at the camera image processing unit 306, any subsequent notifications associated with such an identification may be displayed at the display 308.

In some embodiments, the camera image processing unit 306 may be configured to be connected to a vehicle surveillance unit 310. In certain instances, the vehicle surveillance unit 310 may function as a standalone unit that uses artificial intelligence to assist the camera image processing unit 306 in identifying the living object, the inanimate object, or the person. The vehicle surveillance unit 310 may be configured to be connected to a vehicle display 312, a vehicle alert system 314, at least one vehicle sensor 316, and memory storage 318. The vehicle alert system 314 may include a vehicle alarm, speakers, and/or a siren. The memory storage 318 may include hard disk drive (HDD), solid-state drive (SSD), and/or universal serial bus (USB) storage. The vehicle surveillance unit 310 may be further configured to communicate with a vehicle communication module 320. The vehicle communication module 320 may be additionally configured to communicate with cloud processing unit 330, which may be a remote and centralized database for performing various functions associated with the vehicle-based security system 300. For example, the cloud processing unit 330 may be configured to store images and/or video feed uploaded by a vehicle owner, process images and/or video feed received from the camera 302, and identify an inanimate object, a living object, and/or a person in the images and/or video feed. In certain instances, the cloud processing unit 330 may be configured for connection to a third party database 322 in order to have access to images and/or video feed in those third party databases 322.

In some embodiments, the cloud processing unit 330 may be configured to permit a vehicle owner to set up a patrol area from the vehicle owner's mobile device, personal computer, vehicle display, and/or other input device. In some embodiments, the cloud processing unit 330 may be configured to establish patrol area networks including multiple vehicles, establish multi-network formations, conduct regrouping of assigned vehicles, and establish additional tasks that need to be performed during the execution of the vehicle-based security system 300. In some embodiments, if the vehicles are autonomous, the cloud processing unit 330 may be configured to provide the vehicles with navigational instructions, guidance, geo-tracking capabilities, and searching and identifying operations. In other embodiments, the cloud processing unit 330 may be configured to detect unmanned aircrafts flying within the patrol area. In some embodiments, the cloud processing unit 330 may be configured to assist in contacting an emergency line and/or a designated contact. For example, if a threat has been detected and the threat refuses to exit the patrol area, the cloud processing unit 330 may be configured to assist in dialing emergency services (e.g., law enforcement) and/or the vehicle owner's mobile phone number. The automatic dialing process may be executed with the assistance of voice assistant systems in the vehicle. In some embodiments, the cloud processing unit 330 may be configured to implement a system of globalized and/or localized alert triggers, vehicle alarm(s), and notifications to vehicles and/or mobile devices for implementation in the vehicle-based security system 300. In some instances, the vehicle owner may opt to input parameters associated with alert triggers, vehicle alarm(s), and notifications to vehicles and/or mobile devices.

In some embodiments, each vehicle configured with the vehicle-based security system 300 may be required to report the status of the vehicle in a periodic manner. For example, if a predefined threshold period for reporting the vehicle status is every five minutes, the vehicle-based security system 300 may be configured to require the vehicle to report its patrol status every five minutes if the vehicle is off the vehicle owner's property. Failure to report the vehicle's patrol status in a periodic manner may cause the vehicle-based security system 300 to trigger an alert to the vehicle owner with corresponding notifications. For example, the vehicle owner may receive an alert via email, phone call, text messages, in-app messages, and/or an active voice assistant on the vehicle owner's smart device and/or security systems. The alert may include notifications containing images, video feed, any identified threats (if the threat was successfully identified), vehicle status updates, artificial intelligence decisions during the identification process, and/or inquiries for the vehicle owner. In some instances, the images and/or video feed may be stored at the cloud processing unit 330 for a vehicle owner to download and/or access at a later time.

In some embodiments, although not depicted in FIG. 3, the vehicle-based security system 300 may have a variety of applications. In one embodiment, the vehicle-based security system 300 may be used as a patrol system. If a patrol area is defined to the vehicle-based security system 200 and the vehicle-based security system 300 is activated, a vehicle that is registered to participate in the vehicle-based security system 300 may be configured for activation if the vehicle is proximate to the patrol area and is identified by its vehicle identification number (VIN) and/or a membership code associated with the vehicle's membership with the vehicle-based security system 300. In some embodiments, a user, for example, the vehicle owner, may define the patrol area.

In some instances, the vehicle may be configured to function as a stationary home surveillance system. For example, if the vehicle configured for activation is an electric vehicle, the vehicle may be parked at a home electric vehicle charging station. The vehicle may then be configured to monitor the surroundings within a field of view of the vehicle using infrared cameras and/or visual cameras. In some instances, if the vehicle is an autonomous vehicle, the vehicle may be configured to function as an autonomous patroller to protect the perimeter of the property. The vehicle may further be configured to travel inside and/or outside of the property and make use of available driveways and/or roads in order to patrol the property. If the vehicle is an electric vehicle and is configured for activation, the vehicle may be configured to keep track of a current state of charge of the battery in the vehicle in order to ensure that the vehicle is configured to return to a charging station before the state of charge of the battery falls below a predetermined threshold level. In such an instance, the vehicle may continue to operate as a stationary patrol system when the vehicle is charging at the charging station.

In some instances, if the vehicle detects a threat while on patrol, the threat may be alerted using a variety of alert methods. For example, the vehicle or a third party voice assistant may be used to notify the threat that the vehicle has detected the threat. The vehicle alarm system may also be used to notify the threat. If the threat fails to exit the patrol area, the vehicle may use emit a siren followed by warning notifications that may have been selected by the vehicle owner. In some embodiments, the vehicle may be configured to notify the vehicle owner of the presence of the threat if the threat remains within the patrol area.

In another embodiment, if a patrol area is too large for a single vehicle to patrol, and multiple vehicles proximate to the patrol area can be configured for activation, the multiple vehicles may be configured for activation to patrol the patrol area, thus forming a patrol area network. The multiple vehicles may be configured to operate autonomously and may be navigated by a cloud processing unit, for example, the cloud processing unit 330. The multiple vehicles may be configured to work together in order to provide full coverage to the entire patrol area network. In certain embodiments, additional features may be available. For example, the multiple vehicles may each be configured to configure, activate, and/or command internal drones, robots, and/or mechanical systems to assist in patrolling the area. As an example, if a vehicle detects a threat and activates a security alarm, the vehicle may be configured to deploy at least one robot to assist in protecting the patrol area network. In some instances, the internal drones, robots, and/or mechanical systems may be configured, activated, and/or commanded with the assistance of artificial intelligence systems. In some instances, vehicle components such as doors, hoods, trunks, and other vehicle attachments such as trailers may be controlled by the cloud processing unit. In some instances, operations associated with each of the multiple vehicles may be scheduled in real time.

In some embodiments, the vehicle-based security system 300 may be configured to assist in search and rescue operations, tracking operations, and/or similar operations. For example, visual cameras may be used to obtain images and/or video feed of a field of view from a vehicle. The images and/or video feed may then be compared to images from an image database, for example, the third party database 322, to identify objects and/or people within the images and/or video feed from the visual cameras. In some instances, the identification of living objects, inanimate objects, and/or people within the images and/or video feed may occur at the camera image processing unit 306 at the vehicle. In such an instance, cloud communication capabilities may not be necessary. In other instances, the identification of living objects, inanimate objects, and/or people within the images and/or video feed may occur at the cloud processing unit 330. In such an instance, the cloud processing unit 330 may be connected to another database, for example, a law enforcement database.

Upon identifying the living object, inanimate object, and/or person, the vehicle owner may receive notifications associated with the living object, animate object, and/or person at the vehicle and/or a mobile device associated with the vehicle owner. For example, if a vehicle owner is using the vehicle-based security system 300 to search for a missing pet dog and has provided the vehicle-based security system 300 with at least one image of the missing pet dog, and the vehicle-based security system 300 has identified a dog in images and/or video feed from the visual cameras associated with the vehicle that resembles the missing pet dog, a notification may be provided to the vehicle owner that a similar-looking dog has been identified as proximate to the vehicle, and the notification may further provide directions from the vehicle to the identified dog. In some instances, the notification may be provided verbally via a voice assistance function of the vehicle and/or the mobile device. As an example, the notification may inform the vehicle owner that the identified dog is located on a particular street and/or intersection. In some embodiments, the notification may include a match percentage between the at least one image of the object, for example, the missing pet dog, and the identified living objects, inanimate objects, and/or people. In some instances, the notification may only be transmitted to the vehicle and/or the mobile device if the match percentage is equal to or greater than a match percentage threshold. The match percentage threshold may be a configurable parameter, and, in some instances, the match percentage threshold may be configured by the vehicle owner.

In some instances, the cloud processing unit 330 may be configured to update its accuracy in identifying living objects, inanimate objects, and/or people based on user input. For example, if a vehicle owner provides feedback that the vehicle-based security system 300 has made an error in identification, the cloud processing unit 330 may be trained to improve its identification algorithms.

In some embodiments, if each vehicle is fully autonomous, the each vehicle may be configured to patrol various locations, provide periodic status updates, and upload and store images and/or video feed from the visual cameras to the cloud processing unit 330. In some embodiments, each vehicle may be further configured to deploy drones, robots, and/or mechanical systems from the vehicle to assist in identification operations.

In some embodiments, the cloud processing unit 330 may be configured to process images and/or video feeds from multiple vehicles in real time and simultaneously detect living objects, inanimate objects, and/or people from the images and/or video feeds. In certain embodiments, the cloud processing unit 330 may be additionally configured to receive images and/or video feed from mobile devices, personal computers, or other devices having image-obtaining capabilities. For example, if a vehicle owner is using the vehicle-based security system 300 to search for a missing pet dog, the vehicle owner may provide the cloud processing unit 330 with images of the missing pet dog from the vehicle, the vehicle owner's mobile devices, the vehicle owner's personal computers, or other devices associated with the vehicle owner. In certain embodiments, the cloud processing unit 330 may provide a private web interface for a vehicle owner to add, remove, and edit images that the vehicle owner would like to add to the cloud processing unit 330. In other embodiments, if the vehicle-based security system 300 opts to perform identification functions at the vehicle, the vehicle owner may upload the images of the missing pet dog to an internal hard drive at the vehicle, for example, the memory storage 318.

In some embodiments, the vehicle configured with the vehicle-based security system 300 may operate in several modes. For example, when the vehicle is activated in taxi mode, at least one exterior infrared camera may be used to determine if any living objects and/or people outside of the vehicle have an abnormal temperature. For example, if a living object and/or person has been detected as having a high temperature, the occupants of the vehicle may be notified via the vehicle or a mobile device of the presence of such a living object and/or person having the high temperature. In some instances, doors and/or windows on the vehicle may be locked to prevent entry by the living object and/or person having the high temperature. In an embodiment where the person having the high temperature is the vehicle owner, the vehicle may notify the vehicle owner to consult a doctor via a vehicle display and/or in-vehicle voice commands.

As another example, when the vehicle is activated in animal clinic mode, at least one interior infrared camera may be used to determine if living objects, for example, an animal, have an abnormally high temperature. Temperature readings associated with living objects inside the vehicle may be displayed at vehicle displays and/or transmitted to mobile devices associated with the vehicle owner.

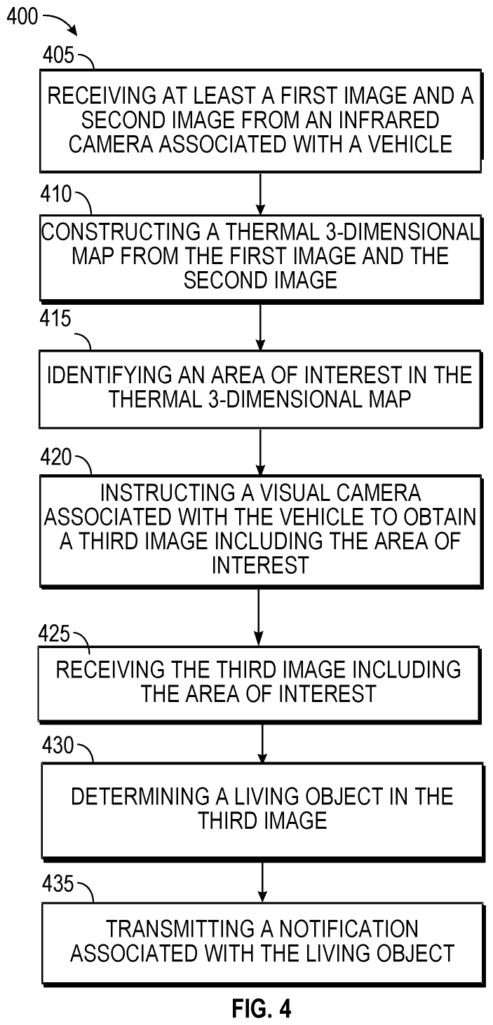

FIG. 4 shows a flow chart 400 of an example method of providing a vehicle-based security system in accordance with the disclosure. The flow chart 400 illustrates a sequence of operations that can be implemented in hardware, software, or a combination thereof. In the context of software, the operations represent computer-executable instructions stored on one or more non-transitory computer-readable media such as a memory 126 provided in the vehicle computer 120, that, when executed by one or more processors such as the processor 122 provided in the vehicle computer 120, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flow chart 400 may be carried out by the vehicle computer 120 either independently or in cooperation with other devices such as, for example, other components of the vehicle 105 and cloud elements (such as, for example, the computer 155 and cloud storage 160).

At block 405, at least a first image and a second image may be received from an infrared camera associated with a vehicle. In some embodiments, a body temperature of the living object disposed inside or outside of the vehicle may be determined using the first image.

At block 410, a thermal 3-dimensional map may be constructed from the first image and the second image. In some embodiments, the thermal 3-dimensional map may be constructed further based on navigational data associated with the vehicle. In some embodiments, it may be determined that additional images are needed to construct the thermal 3-dimensional map. In such an embodiment, the additional images may be received from the infrared camera associated with the vehicle.

At block 415, an area of interest may be identified in the thermal 3-dimensional map.

At block 420, a visual camera associated with the vehicle may be instructed to obtain a third image including the area of interest. In some embodiments, a convertible camera may be associated with the vehicle, where the convertible camera comprises a camera switching module for switching between two modes. In a first mode of the two modes, the convertible camera may be configured to function as the infrared camera. In a second mode of the two modes, the convertible camera may be configured to function as the visual camera. In some embodiments, the convertible camera may be configured to switch from the first mode to the second mode when the area of interest has been identified.

At block 425, the third image including the area of interest may be received.

At block 430, a living object in the third image may be determined. In some embodiments, the determination of the living object may further comprise identifying the living object based on the third image, determining that the living object matches a fourth image in a database of images, and then confirming a presence of the living object based on the determination that the living object matches the fourth image. In such an embodiment, the fourth image may comprise a 2-dimensional black-and-white image.

At block 435, a notification associated with the living object may be transmitted.

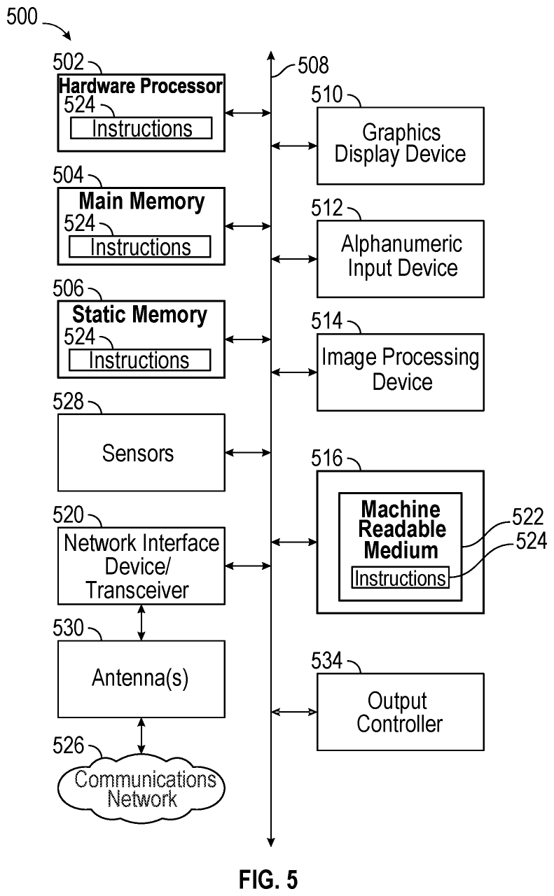

FIG. 5 depicts a block diagram of an example machine 500 upon which any of one or more techniques (e.g., methods) may be performed, in accordance with one or more example embodiments of the present disclosure. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. In some embodiments, the machine 500 may be the vehicle 105, as depicted in FIG. 1. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a graphics display device 510, an alphanumeric input device 512 (e.g., a keyboard), and an image processing device 514. In an example, the graphics display device 510, the alphanumeric input device 512, and the image processing device 514 may be a touch screen display. The machine 500 may additionally include a storage device (i.e., drive unit) 516, a network interface device/transceiver 520 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 406, or within the hardware processor 502 during execution thereof by the machine 500. In an example, one or any combination of the hardware processor 502, the main memory 504, the static memory 506, or the storage device 516 may constitute machine-readable media.

While the machine-readable medium 522 is illustrated as a single medium, the term “machine-readable medium” may include a single medium or multiple media (e.g., a centralized or distributed database, and/or associated caches and servers) configured to store the one or more instructions 524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee®, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 122, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 126, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey the information that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving at least a first image and a second image from an infrared camera associated with a vehicle;
constructing a thermal 3-dimensional map from the first image and the second image;
identifying an area of interest in the thermal 3-dimensional map;
instructing a visual camera associated with the vehicle to obtain a third image including the area of interest;
receiving the third image including the area of interest;
determining a living object in the third image; and
transmitting a notification associated with the living object.

2. The method of claim 1, wherein determining the living object further comprises:
identifying the living object based on the third image;
determining that the living object matches a fourth image in a database of images; and
confirming a presence of the living object based on the determination that the living object matches the fourth image.

3. The method of claim 2, wherein the fourth image comprises a 2-dimensional black-and-white image.

4. The method of claim 1, further comprising:
determining a body temperature of the living object disposed inside or outside of the vehicle using the first image.

5. The method of claim 1, further comprising:
determining that additional images are needed to construct the thermal 3-dimensional map; and
receiving the additional images from the infrared camera associated with the vehicle.

6. The method of claim 1, wherein constructing the thermal 3-dimensional map is constructed further includes constructing the thermal 3-dimensional map based on navigational data associated with the vehicle.

7. A device, comprising:
at least one memory device that stores computer-executable instructions; and
at least one processor configured to access the at least one memory device, wherein the at least one processor is configured to execute the computer-executable instructions to:
receive at least a first image and a second image from an infrared camera associated with a vehicle;
construct a thermal 3-dimensional map from the first image and the second image;
identify an area of interest in the thermal 3-dimensional map;
instruct a visual camera associated with the vehicle to obtain a third image including the area of interest;
receive the third image including the area of interest;
determine a living object in the third image; and
transmit a notification associated with the living object.

8. The device of claim 7, wherein the determination of the living object further comprises:
identify the living object based on the third image;
determine that the living object matches a fourth image in a database of images; and
confirm a presence of the living object based on the determination that the living object matches the fourth image.

9. The device of claim 8, wherein the fourth image comprises a 2-dimensional black-and-white image.

10. The device of claim 7, wherein the computer-executable instructions further comprise computer-executable instructions to:
determine a body temperature of the living object disposed inside or outside of the vehicle using the first image.

11. The device of claim 7, wherein the computer-executable instructions further comprise computer-executable instructions to:
determine that additional images are needed to construct the thermal 3-dimensional map; and
receive the additional images from the infrared camera associated with the vehicle.

12. The device of claim 7, wherein constructing the thermal 3-dimensional map is constructed further includes constructing the thermal 3-dimensional map based on navigational data associated with the vehicle.

13. A vehicle comprising:
an infrared camera, wherein the infrared camera is configured to:
obtain a first image of a first field of view from the vehicle; and
obtain a second image of a second field of view from the vehicle;
a vehicle computer, wherein the vehicle computer is configured to:
construct a thermal 3-dimensional map from the first image and the second image;
identify an area of interest in the thermal 3-dimensional map;
instruct a visual camera associated with the vehicle to obtain a third image including the area of interest; and
determine a living object in the third image; and
the visual camera, wherein the visual camera is configured to obtain the third image including the area of interest.

14. The vehicle of claim 13, wherein determining the living object further comprises:
identifying the living object based on the third image;
determining that the living object matches a fourth image in a database of images; and
confirming a presence of the living object based on the determination that the living object matches the fourth image.

15. The vehicle of claim 14, wherein the fourth image comprises a 2-dimensional black-and-white image.

16. The vehicle of claim 13, wherein the vehicle computer is further configured to:
determining a body temperature of the living object disposed inside or outside of the vehicle using the first image.

17. The vehicle of claim 13, wherein the vehicle computer is further configured to:
determine that additional images are needed to construct the thermal 3-dimensional map; and
receive the additional images from the infrared camera associated with the vehicle.

18. The vehicle of claim 13, further comprising:
a convertible camera comprising a camera switching module for switching between two modes.

19. The vehicle of claim 18, wherein the convertible camera in a first mode of the two modes functions as the infrared camera, and wherein the convertible camera in a second mode of the two modes functions as the visual camera.

20. The vehicle of claim 19, wherein the convertible camera is configured to switch from the first mode to the second mode when the area of interest has been identified.
